(19) United States
(12) Patent Application Publication
(10) Pub. No.: US 2023/0134264 A1
(43) Pub. Date: May 4, 2023

(54) Optical Sensing Apparatus

(71) Applicant: NORWEGIAN UNIVERSITY OF SCIENCE AND TECHNOLOGY (NTNU), Trondheim (NO)

(72) Inventors: Mukesh YADAV, Trondheim (NO); Astrid AKSNES, Trondheim (NO); Dag Roar HJELME, Trondheim (NO); Jens HØVIK, Trondheim (NO)

(73) Assignee: NORWEGIAN UNIVERSITY OF SCIENCE AND TECHNOLOGY (NTNU), Trondheim (NO)

(21) Appl. No.: 17/912,327

(22) PCT Filed: Mar. 18, 2021
(86) PCT No.: PCT/GB2021/050677

§ 371 Date: Sep. 16, 2022

(30) Foreign Application Priority Data
Mar. 19, 2020 (GB) 2004009.3

(51) Int. Cl. G01N 21/77; G01N 21/39; G01N 21/45; B01L 3/00

(52) U.S. Cl. CPC G01N 21/7746; G01N 21/39; G01N 21/45; B01L 3/502761; G01N 2021/458; G01N 2021/7779; B01L 2300/0654; B01L 2300/0816; B01L 2200/0647

(57) ABSTRACT

An optical sensing apparatus is provided comprising: an input interface for receiving input light into the optical sensing apparatus; an input waveguide and a reference waveguide, both arranged to receive input light from the input interface; a closed loop resonator, wherein the input waveguide is optically coupled to the closed loop resonator at an input point for introducing input light to the closed loop resonator; a sample region, adjacent the closed loop resonator, for receiving a sample such that evanescent coupling can occur between light in the closed loop resonator and the sample; a drop-port waveguide, optically coupled to the closed loop resonator at a drop point for receiving dropped light from the closed loop resonator; an output waveguide; and an output interface. The reference waveguide and the drop-port waveguide are arranged to direct interfering light through the output waveguide to produce an output signal at the output interface.

### BACKGROUND OF THE INVENTION

The present invention relates to a system and apparatus for optical sensing, e.g. for use in bio-sensing.

Closed loop or ring resonators are formed from a waveguide that is looped back on itself, such as a circular waveguide. They have a spectral response that is characterised by resonances at wavelengths that are submultiples of the optical path length of the closed loop resonator. Typically, light (e.g. from a laser) is introduced into a ring resonator via evanescent coupling from an adjacent waveguide. The spectral response of the ring resonator may be observed by measuring the intensity of light that couples out of the resonator into a “drop-port” waveguide that is also located adjacent the ring resonator. Alternatively, it may be inferred from the intensity of the light in the input waveguide that does not couple into the resonator (referred to as the “through-port” transmission).

The resonances of the ring resonator can be detected by sweeping the wavelength of monochromatic input light and monitoring the intensity of light at the through port or drop port. At resonant wavelengths, the through-port response dips in intensity (where power is diverted to the ring resonator), and the drop-port response peaks in intensity.

In a ring resonator, the repetition period of the pattern of resonant peaks at the drop port, or of dips at the through port, (which is also referred to as the free spectral range of the resonator) is determined largely by the size of the ring resonator. In general, as the optical path length of the resonator increases (e.g. as the diameter of a circular ring resonator increases), the wavelength spacing between resonances reduces.

It is known to utilise ring resonators to measure properties of samples (e.g. liquid or gaseous biological samples). A sample having a property to be sensed is placed in or adjacent to the optical path of the ring resonator, thereby adjusting the refractive index, and hence the optical path length, of the ring resonator. For example, a chemical sensing layer may be immobilised on a surface of the ring resonator, which may bind a target analyte in the sample within the evanescent field of light in the resonator. The change in optical path length shifts the wavelengths at which resonance peaks occur. The magnitude of the wavelength shift can be measured to determine one or more properties of the sample, such as the concentration of a target analyte in the sample.

However, if the magnitude of the wavelength shift in resonance peaks is comparable to the free spectral range of the ring resonator-based sensor, it becomes difficult or impossible to determine, without ambiguity, the direction and/or the magnitude of the shift. For example, a spectrum in which the peaks have been shifted the equivalent of 90% of a peak separation in one direction would appear to be essentially identical to a spectrum in which the peaks have shifted 10% of the peak separation in the other direction. Similarly, a spectrum that is shifted by 110% of the peak separation may be indistinguishable to a spectrum shifted by 10% of the peak separation.

It may be possible to reduce some of these ambiguities using knowledge of an appropriate expected magnitude of shift, but this may not always be possible (e.g. for an entirely uncharacterised sample).

Another approach is to decrease the size of the ring resonator so as to increase the spacing between resonance peaks and thus increase the dynamic range of the resonator. However, reducing the size of the ring resonator leads to a corresponding decrease in the Q-factor of the resonator (i.e. peaks that are less sharply defined) and thus to a lower sensitivity.

An improved approach is therefore desired.

### SUMMARY OF THE INVENTION

According to a first aspect of the present invention there is provided an optical sensing apparatus comprising:
an input interface for receiving input light into the optical sensing apparatus;
an input waveguide and a reference waveguide, both arranged to receive input light from the input interface;
a closed loop resonator, wherein the input waveguide is optically coupled to the closed loop resonator at an input point for introducing input light to the closed loop resonator;
a sample region, adjacent the closed loop resonator, for receiving a sample such that evanescent coupling can occur between light in the closed loop resonator and the sample;
a drop-port waveguide, optically coupled to the closed loop resonator at a drop point for receiving dropped light from the closed loop resonator;
an output waveguide; and
an output interface,
   wherein the reference waveguide and the drop-port waveguide are arranged to direct interfering light through the output waveguide to produce an output signal at the output interface.

Thus, it will be understood that the apparatus uses interference between light in a reference waveguide and light that is dropped from the closed loop resonator to generate an output signal. The output signal may have a spectral response to the input light that comprises a periodic pattern of resonance peaks that depends at least partially on a property of a sample in the sample region. The use of interference, in combination with resonance, for sensing a sample means that the pattern of peaks in the output signal may have two or more times the period of an equivalent conventional ring resonator-based sensor. In this way, the dynamic range of the whole optical sensing apparatus may be two or more times that of the closed loop resonator. This is because a wavelength-dependent phase offset is established between the dropped light in the drop-port waveguide and the input light in the reference waveguide, such that adjacent resonant peaks in the output signal have different intensities and/or spectral shapes, rather than all having substantially the same intensity as with a conventional ring resonator.

For a conventional optical ring resonator, the free spectral range limits the dynamic range for the sensor. However, in some embodiments of the present invention, the dynamic range may merely be proportional to the free spectral range. It is therefore possible, in some embodiments, to measure, without ambiguity, a larger shift in the resonance peaks, when a sample is introduced to the sample region, without needing to reduce the size of the resonator to increase the spacing between resonance peaks. The optical sensing apparatus may thus have a larger closed loop resonator (i.e. one with a longer optical path length) and still achieve a desired dynamic range , thereby increasing the Q-factor of the resonator and improving the sensitivity of measurements compared with using a resonator on its own. Furthermore, a shift in the pattern of resonant peaks may be identified with an observation of only part of the pattern (i.e. over a limited range of wavelengths that may not cover the whole pattern repetition unit). This may reduce the range of input light wavelengths required to establish the magnitude of a shift without ambiguity, which can reduce the required wavelength range, and thus cost and complexity, of a light source (e.g. tunable laser) for use with the apparatus.

The pattern of resonant peaks is achieved by interfering dropped light from the closed loop resonator with input light carried by the reference waveguide. Because the light is introduced to the closed loop resonator by the input waveguide at an input point, and dropped light is received from the closed loop resonator by the drop-port waveguide at a different drop point, there will be a phase offset between the input light in the reference waveguide and the dropped light in the drop-port waveguide, when the input light and dropped light interfere, that depends on the wavelength of the input light. Therefore, at different resonances of the closed loop resonator (i.e. at wavelengths of the input light which are submultiples of the optical path length of the closed-loop resonator) the phase offset between the input light in the reference waveguide and the dropped light in the drop-port waveguide will change. The dropped light in the drop-port waveguide will thus interfere differently with the input light in the reference waveguide at different resonance peaks, producing a pattern of resonance peaks in the output signal with different intensities.

The pattern of resonance peaks has a period that depends at least partially on the configuration of the input waveguide, closed loop resonator and the drop-port waveguide. The separation between the input point and the drop point can introduce a wavelength-dependent phase difference between the input light at the input point and the dropped light at the drop point. In some sets of embodiments, the input point and the drop point are separated by half the path length of the closed loop resonator. In such embodiments the dropped light at the drop point and the input light at the input point will be phase offset by π when the optical path length around the whole closed loop resonator is equal to an odd number of wavelengths of the input light, and will be in phase when the optical path length around the whole closed loop resonator is equal to an even number of wavelengths of the input light. This leads to a pattern of resonance peaks in the output signal with a period of two resonance peaks. This may be double the dynamic range of a same-sized conventional ring resonator-based sensor.

However, the dynamic range of the apparatus (corresponding to the period of the repeating pattern of peaks in the output signal) may advantageously be further increased by adjusting the separation of the input point and the drop point away from half the path length. Thus, in some sets of embodiments, the input point and the drop points are separated by less than half the optical path length of the closed loop resonator. (Of course, because the resonator is a loop, these points can also be seen as being separated by more than half the optical path length, when measured around the longer arc of the loop.) This results in the pattern of resonance peaks having period of three or more resonance peaks (i.e. at least three times the free spectral range of a conventional ring resonator sensor). For example, the input point and the drop point may be separated by less than 45% of the optical path length of the closed loop resonator. In some sets of embodiments the closed loop resonator is convex (e.g. circular) and the input point and the drop point have an angular separation around the closed loop of less than 180° and preferably less than 160°.

Preferably, the input point and the drop point are separated by an optical path length that is a submultiple (i.e. a unit fraction) of the optical path length of the closed loop resonator, such as a third, a quarter, a fifth, a sixth, a seventh or an eighth of the optical path length of the closed loop resonator. Such configurations can help to produce clear patterns of resonance peak intensities. For example, for a convex closed loop resonator (e.g. a circular resonator) preferably the input point and the drop point are separated by an angle of approximately 45°, 60°, 90°, or 120°. More generally, in some embodiments, the input point and the drop point may be separated by an optical path length that is a common fraction of the optical path length of the closed loop resonator, such as three-eighths of the optical path length of the closed loop resonator. For example, for a convex closed loop resonator (e.g. a circular resonator) the input point and the drop point may be separated by an angle of approximately 135°.

It will be appreciated that the optical path length of the closed loop resonator will change when a suitable sample is introduced to the sample region. For some embodiments, the optical path length around the closed loop resonator may refer to the path length when no sample is present. However, in some embodiments, so long as the sample affects the resonator fairly uniformly around the length of the resonator, the separation distance between the input and drop points will scale substantially in proportion with the optical path length, so the same path length proportions can be preserved, whether a sample is present or not. In some embodiments, the sample region may not extend entirely uniformly over the closed loop resonator; for example, the sample region may exclude areas located at or adjacent the input and/or drop points of the resonator, to prevent undesirable interaction by the sample with the evanescent field of light in the input and/or drop port waveguides.

The input waveguide may be optically coupled to the closed loop resonator by being physically connected (i.e. such that light in the input waveguide is simply directed into the closed loop resonator). However, in some embodiments the input waveguide may be coupled to the closed loop resonator by evanescent coupling, where the input waveguide and the closed loop resonator are physically separate but are brought sufficiently close together that the evanescent field of light in the input waveguide extends into the closed loop resonator so as to couple light into the closed loop resonator.

As mentioned above, embodiments of the invention enable a closed loop resonator with an increased optical path length to be used without sacrificing dynamic range.

In some embodiments, the closed loop resonator comprises an optical path length of at least 100 μm, 200 μm, 300 μm, 500 μm, 600 μm, 700 μm, or even 800 μm or more. For example, the closed loop resonator may comprise a circular waveguide with a diameter of approximately 100 μm or more.

In some embodiments of the invention, the optical sensing apparatus further comprises a through-port waveguide arranged receive light from the input waveguide that does not couple into the closed-loop resonator. It may be arranged to produce a through-port output signal at a through-port output interface. The spectrum of the through-port output signal will comprise dips corresponding to resonances of the closed loop resonator (where power is diverted from the input waveguide into the closed loop resonator). Whilst the spectrum of the through-port output signal may not have the increased free spectral range of the pattern observed at the output interface, it may still be useful for refining the position of individual peaks identified in the interference output signal.

The through-port waveguide may simply be a continuation of the input waveguide after it has optically coupled to the closed loop resonator, although it could alternatively comprise a separate waveguide that is optically coupled to the input waveguide.

As explained above, at some resonances the input light in the reference waveguide will be offset in phase relative to dropped light in the drop-port waveguide, at a point at which the input light and dropped light interfere, with the amount of phase offset determined by the wavelength of the input light, and by the configurations of the closed-loop resonator, the input waveguide and the drop-port waveguide. Whilst any measureable difference in the intensities and/or spectral shapes of resonant peaks may be sufficient to increase the dynamic range of the resonator, it may be desirable to maximise the difference in intensities of resonant peaks in the output signal. It may also be desirable to optimise the performance of the optical sensing apparatus for input light with a wide range of wavelengths.

In some sets of embodiments, therefore, the total optical path length from the input interface to the output interface through the reference waveguide is equal to: the optical path length from the input interface to the input point of the closed loop resonator, plus the optical path length from the drop point of the closed loop resonator to the output interface. In such embodiments, the optical sensing apparatus is “balanced” in that the input light and dropped light interfering in the output waveguide have travelled respective distances that differ by an integer number of wavelengths, for all resonant wavelengths, except for a further constant phase difference due to the non-zero separation of the input and drop points of the closed loop resonator. The only phase offset between the input light and the dropped light will therefore be the constant phase offset introduced by the closed loop resonator, regardless of the wavelength of the input light (since there is no dropped light when the input light is not at a resonant wavelength). Furthermore, if there are resonances where no phase offset is introduced by the closed loop resonator (e.g. for wavelengths that are submultiples of the separation distance between the input and drop points in embodiments in which the path length of the closed loop resonator is an integer multiple of the separation distance between the input and drop points), the dropped light and input light will interfere constructively to produce a maximum intensity peak.

In some embodiments the reference waveguide branches from the input waveguide at a branch point within the optical sensing component and merges with the drop-port waveguide at a merge point within the optical sensing component. The reference waveguide may have an optical path length between the branch point and the merge point that is equal to an optical path length of the input waveguide between the branch point and the input point plus an optical path length of the drop-port waveguide between the drop point and the merge point.

More generally, the apparatus may comprise an optical splitter (e.g. a Y-branch splitter) comprising an input optically coupled to the input interface, a first output optically coupled to the reference waveguide, and a second output optically coupled to the input waveguide. It may comprise an optical combiner (e.g. a Y-branch combiner) comprising a first input optically coupled to the reference waveguide, a second input optically coupled to the drop-port waveguide, and an output optically coupled to the output waveguide.

As explained above, the presence of a sample in the sample region may cause the resonance peaks in the output signal to shift from their position when no sample is held in the sample region, or when a control substance, such as an aqueous buffer solution, is held in the sample region. The magnitude of the shift may be indicative of one or more properties of the sample, such as the concentration of a target analyte in the sample, or of a refractive index of the sample.

However, the Applicant has recognised that the resonance peaks may also shift for other reasons, causing errors in measurements. For example, a change in the ambient temperature may cause the optical path length of the closed loop resonator to change due to thermal expansion and/or changes in the resonator's optical properties. If such a change in ambient temperature were to happen between a control measurement and an analyte being added to the sample region, the shift in resonance peaks due to the change in ambient temperature may be indistinguishable from the shift due to the presence of the analyte.

Environmental factors such as ambient temperature may therefore be monitored separately and compensated for retroactively (e.g. by using a look-up table or previously characterised relationship), but this may not be possible or sufficiently accurate for all factors effecting the positions of resonance peaks (e.g. physical stresses on the closed loop resonator).

In some sets of embodiments, additionally or alternatively, the optical sensing apparatus comprises a second closed loop resonator and a second sample region adjacent the second closed loop resonator. The input waveguide may be optically coupled to a (second) input point on the second closed loop resonator for introducing input light to the second closed loop resonator. The drop-port waveguide may be optically coupled to a (second) drop point on the second closed loop resonator for receiving dropped light from the second closed loop resonator. The apparatus may be arranged to additionally interfere light dropped from the second closed loop resonator with light from the reference waveguide. The spectrum of the output signal may comprise a first pattern of resonance peaks corresponding to the (first) closed loop resonator and a second pattern of resonance peaks corresponding to the second closed loop resonator. Alternatively, the (second) drop point on the second closed loop resonator may be coupled to a second output interface of the apparatus to output a second output signal separate from the (first) output signal; this may advantageously reduce the computational burden on the processing system, by generating two separate spectra directly, rather than a combined spectrum, but it may require a second light detector which may increase hardware costs.

In some embodiments, the sample region is spaced apart from the second sample region. The sample region may be arranged to hold a first substance (e.g. comprising a target analyte) whilst the second sample region may be arranged to hold a second substance (e.g. comprising the same or a different analyte, or a control substance such as an aqueous buffer solution or air). The apparatus may provide an opening or well (e.g. in an optical cladding layer), for retaining a sample in the sample region, although this is not essential. In some embodiments, the first pattern of resonance peaks corresponds to a first substance and the second pattern of resonance peaks corresponds to a second substance.

The second closed loop resonator may have the same path length as the (first) closed loop resonator. The spacing of the first pattern of resonance peaks in the output signal may then be substantially identical to that of the second pattern of resonance peaks when no samples are present. When the (first) sample region holds a sample and the second sample region holds a control substance, a wavelength separation between the first and second patterns may then be measured to determine one or more properties of the sample, without needing to perform a control measurement and with environmental effects inherently accounted for (because the second closed loop resonator will be subject to similar if not identical environmental conditions to the first closed loop resonator and thus the first and second patterns would be affected substantially identically by any change in environment conditions).

In other embodiments, the second closed loop resonator may have a different path length to the (first) closed loop resonator (e.g. the closed loop resonators may comprise circular waveguides with different diameters), such that the spacing of the first pattern of resonance peaks in the output signal is different to that of the second pattern of resonance peaks. This may make it easier to distinguish between resonance peaks produced from the closed loop resonator and the second closed loop resonator.

In some sets of embodiments featuring a second closed loop resonator, the second input point and drop points may be separated by a fraction of the optical path length of the second closed loop resonator that is equal to the fraction of the optical path length of the (first) closed loop resonator by which the (first) input and drop points are separated. In such cases, the first and second patterns of resonance peaks may be similar (i.e. they may share a common characteristic pattern), although the spacing between peaks may differ if the first and second closed loop resonators have different optical path lengths, e.g. by having different fabricated path lengths, or by being exposed to samples that affect their refractive indexes differently. For example, in an embodiment where the closed loop resonator and the second closed loop resonator comprise circular waveguides, the (first) input and drop points and the second input and drop points may both be separated the same angle around the circular waveguide (e.g. 90° or 180°).

Alternatively, the second input point and drop points may be separated by a fraction of the optical path length of the second closed loop resonator different to the fraction of the optical path length of the closed loop resonator by which the (first) input and drop points are separated. In such cases, the first and second patterns of resonance peaks may be dissimilar, which may allow the first and second patterns to be more easily distinguished in a combined output signal.

In some embodiments featuring a second closed loop resonator, the drop-port waveguide may comprise a first arm that is optically coupled to the closed loop resonator and a second arm that is optically coupled to the second closed loop resonator. The first and second drop-port waveguide arms may be arranged such that the optical path length from the input interface to the input point plus the optical path length from the drop point to the output interface, is equal to the optical path length from the input interface to the second input point plus the optical path length from the second drop point to the to the output interface. For example, the second arm may be shorter than the first arm to compensate for a second closed loop resonator that is further from the input interface than the (first) closed loop resonator.

The closed loop resonator (and the second closed loop resonator) may comprise any waveguide that is looped back on itself. A closed loop resonator may, for example, be circular or ellipsoidal. Some examples of closed loop resonators which may be used in embodiments of the apparatus include ring resonators, racetrack resonators, microdisk resonators, microsphere resonators, microcapillary resonators, microtoroid resonators or optical fibre-based resonators.

The apparatus may comprise any number of closed loop resonators—e.g. two, three, five, ten or more. They may all be arranged to output drop-port light that interferes with light in the reference waveguide. This can enable multiplexed analysis of a large number of analytes (which could be in a common sample or in different samples) to be performed simultaneously using the one apparatus.

One or more of the waveguides of the optical sensing apparatus may comprise a planar waveguide, a strip waveguide, a rib waveguide, a slot waveguide or a segmented waveguide. One or more of the waveguides may comprise an optical fibre. One or more of the waveguides may be formed at least in part using glass, polymer or a semiconductor material (e.g. silicon). One or more of the waveguides may comprise a single-mode waveguide. One or more of the waveguides may comprise a multi-mode waveguide.

The optical sensing apparatus may comprise a substrate (e.g. a silicon, glass, polymer or silicon nitride substrate) on which one or more of the elements of the optical sensing apparatus (e.g. the waveguides and/or closed loop resonator(s)) are formed. The optical sensing apparatus may be a monolithic component (e.g. a photonic chip). The optical sensing apparatus may comprise a semiconductor material and/or dielectric material (e.g. silicon dioxide). The semiconductor material and/or dielectric material may be grown on a substrate (e.g. glass, silicon, or a group III-IV material substrate). For example, a semiconductor material and/or dielectric material may be grown by means of an epitaxial process (e.g. molecular beam epitaxy) or a deposition process (e.g. a sputtering process or chemical vapour deposition). The elements of the optical component may be monolithically integrated onto a substrate of the optical component, which may be a planar substrate.

The sample region may comprise a sensing layer, which may be located adjacent one or more of the closed loop resonators. The sensing layer may be immobilised on a surface of the ring resonator. The sensing layer may be arranged to bind a target analyte in a sample when the sample is present in the sample region. A plurality of different sample layers, which bind different respective target analytes, may be located adjacent different respective closed loop resonators.

According to a second aspect of the present invention there is provided a sensing system comprising:
the optical sensing apparatus as disclosed herein;
a light source arranged to provide input light to the input interface of the optical sensing component; and
a light detector arranged to receive the output signal from the output interface of the optical sensing component.

The light source may be a monochromatic light source. It may be a spatially-coherent light source (e.g. when single-mode waveguides are used). Preferably the wavelength of monochromatic light provided by the light source is adjustable (i.e. the light source comprises a tunable light source). As mentioned above, the pattern of resonance peaks in the output signal means that only a subset of the resonance peaks in the pattern may need to be observed to establish the magnitude of a shift without ambiguity. Thus the range of wavelengths over which the output signal needs to be observed to identify unambiguously a shift in the positions of the resonance peaks may be smaller compared to conventional approaches. The light source may have a tunable range (i.e. the range of wavelengths of monochromatic light the light source is able to produce) which is of the same order as, or which is equal to or greater than, twice the free spectral range of the closed loop resonator and/or equal to or greater than the period of a pattern of resonance peaks in the output signal. The tunable range of the light source is preferably less than 20 nm and further preferably less than 15 nm, e.g. 10 nm, 8 nm or 5 nm or less. This may reduce the cost and complexity of the light source that can be used satisfactorily with embodiments of the invention.

In some sets of embodiments, the light source comprises a tunable laser (e.g. an external-cavity tunable diode laser , a distributed Bragg reflector laser, a distributed feedback semiconductor laser, or a solid state laser such as an Nd:YAG laser).

The light detector may comprise any device capable of measuring an intensity of incident light, e.g. a photodetector.

The sensing system may comprise a processing system or device, which may be arranged to receive an electrical signal from the light detector. The processing system may be configured to process the electrical signal to determine a property of a sample in the sample region. It may be arranged to record a spectrum of light detected by the light detector—e.g. as the wavelength of the light source is changed over time. The processing system may be arranged to determine a position of a resonance peak in a spectrum of light detected by the light detector. The processing device may be arranged to compare two spectra to determine a shift in resonance peaks.

In some embodiments, the processing system is configured to:
determine data representative of a spectral response of the optical sensing apparatus to the input light;
access stored data representative of a predetermined spectral pattern; analyse the spectral response to detect the predetermined spectral pattern in the spectral response;
determine a position of the predetermined spectral pattern within the spectral response; and
determine the property of a sample in the sample region at least in part based on said position.

The processing system may perform a cross-correlation operation to determine the position of the predetermined spectral pattern within the spectral response. The processing system may be configured to determine the positions of a plurality of predetermined spectral patterns within the spectral response—e.g. corresponding to different respective closed loop resonators.

The sensing system may comprise a second light detector arranged to receive light from the through-port output interface of the optical sensing component. The processing system may be arranged to determine a through-port spectrum of light detected by the second light detector. The processing system may be arranged to determine a position of a resonance peak in a through-port spectrum. The processing system may be arranged to use a determined position of a resonance peak in a through-port spectrum to determine and/or refine the position of a resonance peak in a spectrum of light detected by the light detector.

The sensing system may comprise a controller arranged to control the wavelength of light provided by the light source. The controller may be arranged to control the light source so as to sweep the wavelength of input light across a predefined range.

The processing system may acquire a series of spectra over time. It may process these to monitor a property of the sample over time—e.g. to measure a rate of change in concentration of an analyte.

The processing system may comprise a processor and a memory storing software instructions which, when executed by the processor, perform any of the processing steps disclosed herein. The processing system may be local to or remote from the optical sensing apparatus. It may comprise a remote server.

The light source and light detector may be coupled to the optical sensing apparatus via one or more optical fibres.

Features of any aspect or embodiment described herein may, wherever appropriate, be applied to any other aspect or embodiment described herein. Where reference is made to different embodiments, it should be understood that these are not necessarily distinct but may overlap.

### BRIEF DESCRIPTION OF THE DRAWINGS

One or more non-limiting examples will now be described, by way of example only, and with reference to the accompanying figures in which:

FIG. 1 is a schematic plan view of an optical sensing component according to a first embodiment of the invention;

FIG. 2 is a schematic partial cross-sectional side view of the optical sensing apparatus along the line A-A shown in FIG. 1;

FIG. 3 is a graph of part of the spectral response at the through-port output of the optical sensing component shown in FIGS. 1 and 2;

FIG. 4 is a graph of part of the spectral response at the output of the optical sensing component shown in FIGS. 1 and 2;

FIG. 5 is a schematic plan view of an optical sensing component according to a second embodiment of the invention;

FIG. 6 is a graph of the components in the spectral response measured at the output of the optical sensing component shown in FIG. 5;

FIG. 7 is a graph of the spectral response measured at the output of the optical sensing component shown in FIG. 5;

FIG. 8 is a perspective schematic view of a sensing system according to an embodiment of the present invention;

FIG. 9 is a photographic slide of an exemplary fabricated photonic chip embodying the invention; and

FIG. 10 is a graph of the measured spectral response of the exemplary photonic chip shown in FIG. 9.

### DETAILED DESCRIPTION

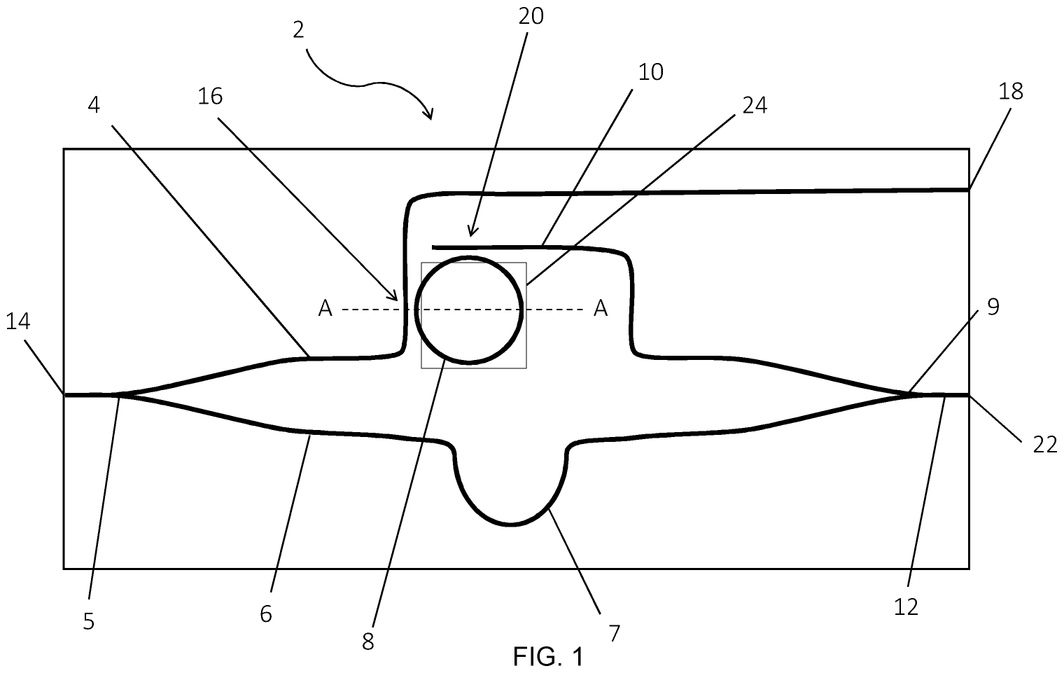

As illustrated in FIG. 1, an optical sensing apparatus 2 comprises a base substrate 1 (e.g. of silicon) supporting a lower cladding layer 3 (e.g. a silicon dioxide substrate) onto which a network of strip waveguides (e.g. of crystalline silicon) are formed. These waveguides include an input waveguide 4, a reference waveguide 6, a ring resonator 8 (in this case comprising a circular waveguide), a drop-port waveguide 10 and an output waveguide 12. The apparatus 2 may have a solid upper cladding layer 11 (e.g. a further oxide layer) over most of its surface, or it may have no upper cladding layer and instead employ a gaseous or liquid cladding layer when in use.

The input waveguide 4 and the reference waveguide 6 are both arranged to receive input light from an input interface 14, via a Y-branch splitter 5. The reference waveguide 6 comprises a compensation curve 7, which, as explained in more detail below, is dimensioned to optimise the performance of the apparatus 2.

The input waveguide 4 passes adjacent the ring resonator 8, with the point of closest approach being at a first point 16, and continues to a through-port output interface 18. The drop-port waveguide 10 passes adjacent the ring resonator 8, with the point of closest approach being at a second point 20, and goes on to merge with the reference waveguide 6, at a Y-branch combiner 9. The Y-branch combiner 9 leads to the output waveguide 12, which carries output light to an output interface 22. The first point 16 and the second point 20 are separated by a path length along the ring resonator 8 that is approximately a quarter of the total path length of the ring resonator 10 (i.e. consisting of a 90° arc around the circular waveguide 8).

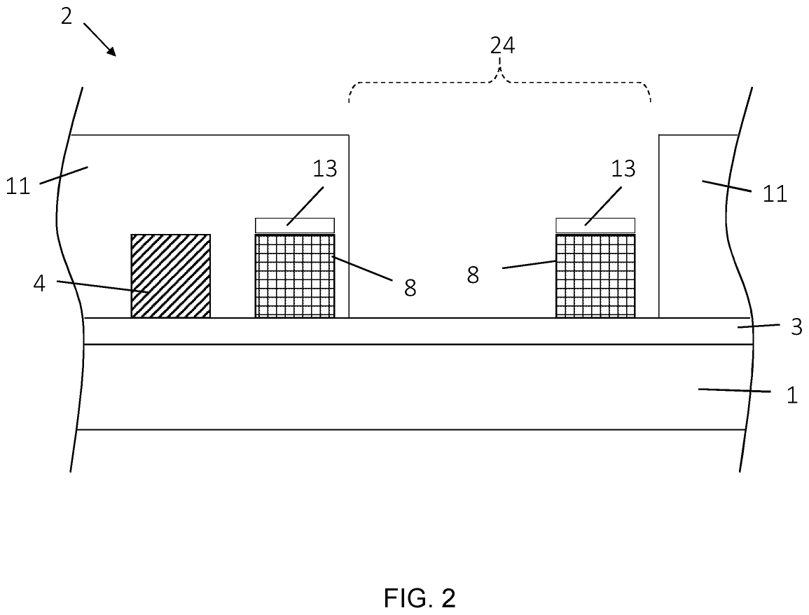

As shown in FIGS. 1 and 2, the optical sensing apparatus 2 has a sample region 24 that is located above the ring resonator 8. This region 24 may be defined by an opening in an upper cladding layer (e.g. a square well for holding a liquid sample), or it may comprise a region of free space adjacent a face of the apparatus 2. The region 24 further comprises a sensing layer 13 of receptor molecules, immobilised on the surface of the ring resonator 8. The sensing layer 13 may cover the whole ring resonator 8, or, as shown in FIG. 1, it may have small breaks by the first and second points 16, 20, so that the sample does not have an undesired effect on the input waveguide 4 and drop-port waveguide 10. When a sample (e.g. a biological analyte) is present in the sample region 24, a target molecule can bind to the receptor molecules and interact with the evanescent field of light in the ring resonator 8, changing the effective optical path length of the ring resonator 8.

The optical sensing apparatus 2 in this example is a single monolithic component, e.g. a photonic chip, although this is not essential.

In use, monochromatic light (e.g. from a tunable laser) is provided to the input interface 4 (e.g. via an optical fibre, not shown in FIG. 1). The light passes along the input waveguide 4 and the reference waveguide 6. As light in the input waveguide 4 passes the ring resonator 8, it can couple light into the ring resonator 8 via evanescent coupling. Similarly, light in the ring resonator 8 couples into the drop-port waveguide 10 via evanescent coupling.

When the optical path length of the ring resonator 8 is not an integer multiple of the wavelength of the input light, there is no resonance and minimal power is diverted into the ring resonator 8 from the input waveguide 4. The intensity of light at the through-port output interface 18 is thus substantially equal to the intensity of the input light received by the input waveguide 4. Similarly, minimal power is in turn coupled into the drop-port waveguide 10. The light in the output waveguide 12 arriving at the output interface 22 thus has an intensity approximately equal to that of the input light received by the reference waveguide 6.

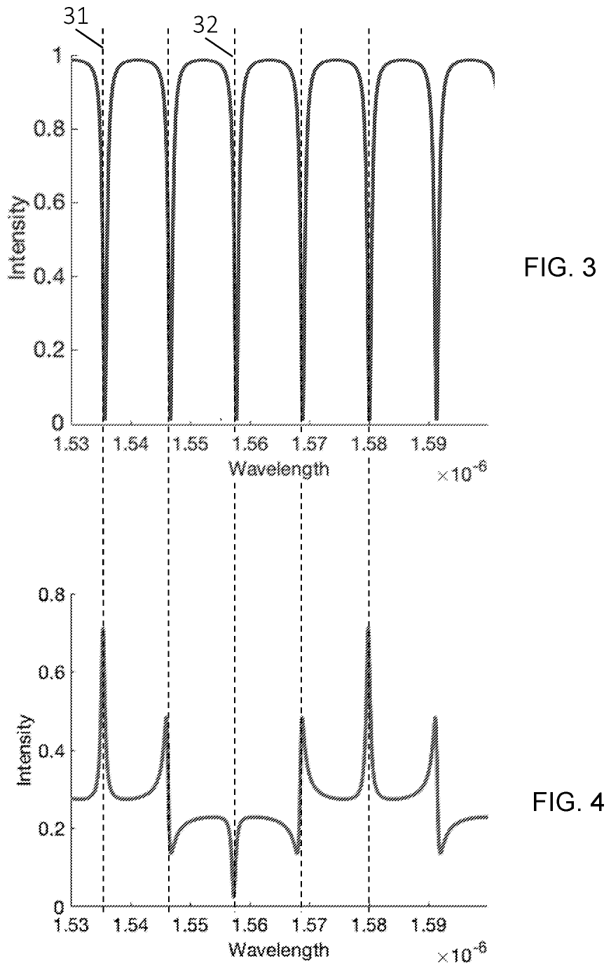

FIG. 3 shows the intensity of light emanating from the through-port output interface 18, as a function of input wavelength. It can be seen that, at and around a wavelength of approximately 1.54×10⁻⁶ m, for example, no resonance occurs and the intensity of light at the through-port output interface 18 is roughly constant at 1.

However, when the optical path length of the ring resonator 8 is an integer multiple of the wavelength of the input light, waves in the ring resonator 8 interfere constructively and a resonant standing wave is set up in the ring resonator 8. Almost all of the light from the input waveguide 4 couples to the ring resonator 8 and the intensity of light at the through-port output interface 18 drops to near zero. This can be seen in FIG. 3 for a wavelength of approximately 1.58×10⁻⁶ m, for example.

FIG. 4 shows the intensity of light emanating from the output interface 22, as a function of input light wavelength. It can be seen that, at and around an exemplary non-resonant wavelength of 1.54×10⁻⁶ m, the intensity of the light at the output interface 22 is roughly constant at 0.3.

The phase difference in the standing wave in the ring resonator 8 between the first point 16 and the second point 20 is dependent upon the separation of the first and second points 16, 20 and upon the wavelength of the light. When the separation between the first and second points 16, 20 is equal to an integer number of wavelengths of the input light, the two points are in phase. This situation is exemplified at the first dashed line 31 in FIGS. 3 & 4. When the separation between the first and second points 16, 20 is equal to an integer number of wavelengths plus half a wavelength, the two points are exactly out of phase. This situation is exemplified at the second dashed line 32 in FIGS. 3 & 4. For other resonant wavelengths, the phases of the light at the two points 16, 20 may have a difference somewhere between 0 and π.

Therefore, at resonant wavelengths, light coupled into the drop-port waveguide 10 has a wavelength-dependent phase difference, at the Y-branch combiner 9, relative to light in the reference waveguide 6. The phase difference is different for different resonances.

For the apparatus 2 described with reference to FIGS. 1-4, the separation between the first and second points 16, 20 is a quarter of the optical path length of the ring resonator 8 (an angular separation of 90°). Thus, the phase difference between light in the drop-port waveguide 10 and light in the reference waveguide 6, when they join at the at the Y-branch combiner 9, changes by 2π/4 for successive resonances. By carefully selecting the length of the compensation curve 7, the apparatus can be tuned such that the light in the drop-port waveguide 10 and the light in the reference waveguide 6 are exactly in phase, at the Y-branch combiner 9, for every fourth resonant peak. For the three intermediary resonant peaks, the phase difference between light in the drop-port waveguide 10 and the reference waveguide 6 at the Y-branch combiner 9 will be, successively, π/2, π (i.e. out-of-phase) and 3π/2.

Thus, the intensity of light at the output interface 22, at successive resonant peaks, cycles through four values:
a maximum value corresponding to complete constructive interference between the light in the drop-port waveguide 10 and the reference waveguide 6 (where they are in-phase);
a first intermediary value corresponding to partial constructive interference;
a minimum value (i.e. zero) corresponding to complete destructive interference; and
a second intermediary value corresponding to partial constructive interference.

The peaks with the first and second intermediary values also have a different spectral shape (e.g. comprising sudden dips or rises in intensity).

Thus, the pattern of peaks in the intensity of the output interface 22 shown in FIG. 4 has a period of four times the separation of adjacent resonant peaks of the ring resonator 8 in FIG. 3.

The optical sensing apparatus 2 may be used to determine properties of and/or identify a sample (e.g. to detect a particular analyte in a biological sample). First, a control measurement of the spectral response of the optical sensing apparatus is made (e.g. with only an aqueous buffer solution present in the sample region 24) by sweeping the wavelength of the input light over a predefined range and observing the pattern of resonant peaks at the output interface 22.

A sample is then introduced to the sample region 24, and the spectral response of the optical sensing apparatus 2 again measured by sweeping the wavelength of the input light over the predefined wavelength range and observing the pattern of resonant peaks at the output interface 22. Because the analyte in the sample region can interact with the sensing layer 13 to change the optical path length of the ring resonator 8, the wavelengths at which resonances occur (i.e. the positions of the resonant peaks) shift. The magnitude of this shift can be measured to determine the presence of and/or properties of a target analyte in the sample region 24. In some cases the spectral response may be continuously measured (i.e. by repeatedly sweeping the wavelength of the input light) as the sample interacts with the sensing layer 13, such that the shift in the positions of the resonant peaks can be observed over time—and potentially in real time. Because the pattern of intensities of peaks in the output signal has, in this example, a period of four resonant peaks, a large shift (e.g. of up to 0.045×10⁻⁶ m) may be observed without ambiguity.

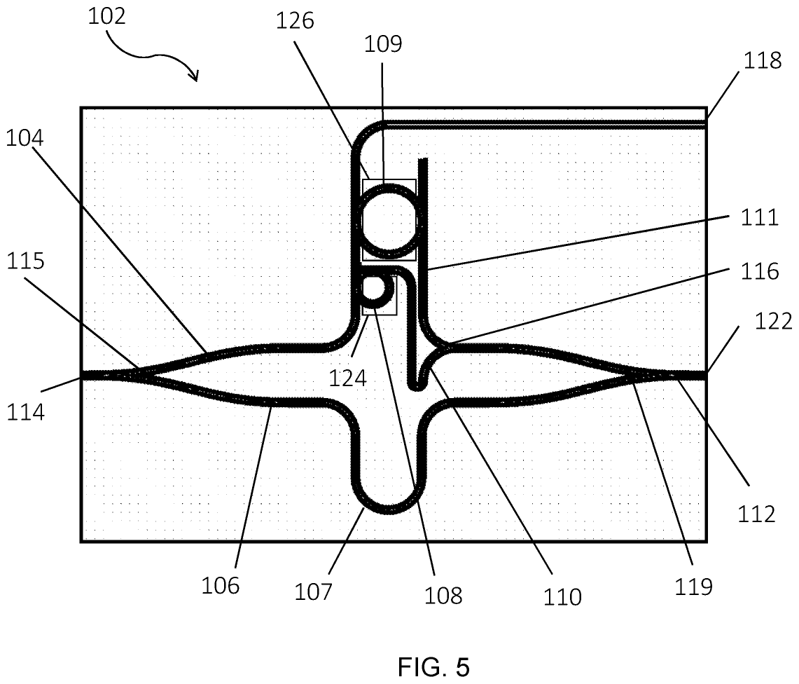

Another optical sensing apparatus 102 is shown in FIG. 5. The optical sensing apparatus is similar to that of FIG. 1. It comprises a substrate (e.g. a silicon substrate) onto which an input waveguide 104, a reference waveguide 106, a first ring resonator 108, a second ring resonator 109, a first drop-port waveguide arm 110, a second drop-port waveguide arm 111 and an output waveguide 112 are formed. The input waveguide 104 and the reference waveguide 106 are both arranged to receive input light from an input interface 114, via a Y-branch splitter 115. The reference waveguide 106 comprises a compensation curve 107. The first ring resonator 108 comprises a circular waveguide with a first diameter (e.g. of around 50 μm). The second ring resonator 109 comprises a second waveguide with a second, larger diameter (e.g. of around 100 μm).

The input waveguide 104 passes adjacent the first ring resonator 108 and the second ring resonator 109, and continues to a through-port output interface 118. The first drop-port waveguide arm 110 passes adjacent the first ring resonator 108, and the second drop-port waveguide arm 111 passes adjacent the second ring resonator 109. The points at which the input waveguide 104 and the first drop-port waveguide arm 110 pass closest to the first ring resonator 108 are separated by a quarter of the optical path length of the first ring resonator 108 (i.e. 90° around the circular waveguide). The points at which the input waveguide 104 and the second drop-port waveguide arm 110 pass closest to the second ring resonator 109 are separated by half of the optical path length of the second ring resonator 108 (i.e. 180° around the circular waveguide).

The first and second drop-port waveguide arms 110, 111 go on to merge at a first Y-branch combiner 116 to form a common drop-port waveguide which then merges with the reference waveguide 106 at a second Y-branch combiner 119. This becomes the output waveguide 112, which carries output light to an output interface 122. The first drop-port waveguide 110 includes a U-shaped compensation curve so that the paths through the first and second ring resonators 108, 109 can each be balanced relative to the reference waveguide 106, for their respective resonant wavelengths.

The optical sensing apparatus 102 comprises a first sample region 124 located above the first ring resonator 108 and a second sample region 126 located above the second ring resonator 109. A sample (e.g. a biological analyte) present in the first or second sample region interacts with the evanescent field of light in the first or second ring resonator 108, 109 respectively, changing the optical path length of the first or second ring resonator 108, 109. The two sample regions 124, 126 may be physically separated so that they can hold two different samples (e.g. two different analytes, or an analyte and a control substance) simultaneously, or the first and second ring resonators 108, 109 may have different chemical sensing layers bonded to respective exposed faces.

In use, monochromatic light (e.g. from a laser) is provided to the input interface 104 (e.g. via an optical fibre, not shown). The light passes along the input waveguide 104 and the reference waveguide 106. As light in the input waveguide 104 passes the first and second ring resonators 108, 109, it couples light into the ring resonators 108, 109 via evanescent coupling. Similarly, at appropriate wavelengths, light in the ring resonators 108, 109 couples light into the first and second drop-port waveguides 110, 111 via evanescent coupling.

As with the ring resonator 8 of the optical sensing apparatus 2 described above with reference to FIGS. 1-4, the first and second ring resonators 108, 109 each exhibit resonances when the wavelength of the input light is a submultiple of their optical path lengths. The first and second ring resonators 108, 109 are different sizes and thus resonate at different (potentially overlapping) sets of wavelengths. Away from these resonances (i.e. at a wavelength that is not a submultiple of the optical path length of either ring resonator 108, 109), there is minimal power in the drop-port waveguides 110, 111 and the light in the output waveguide 112 output by the output interface 122 has an intensity approximately equal to that of the input light received by the reference waveguide 106.

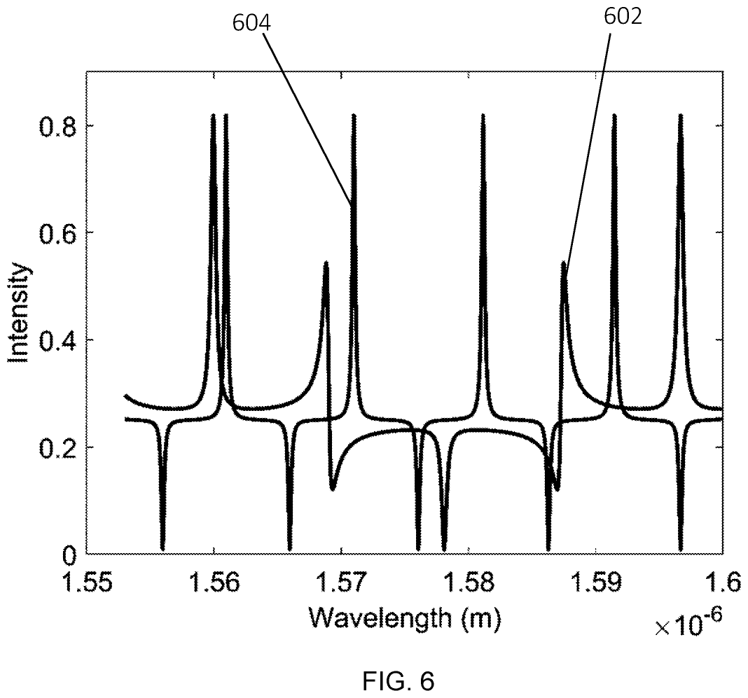

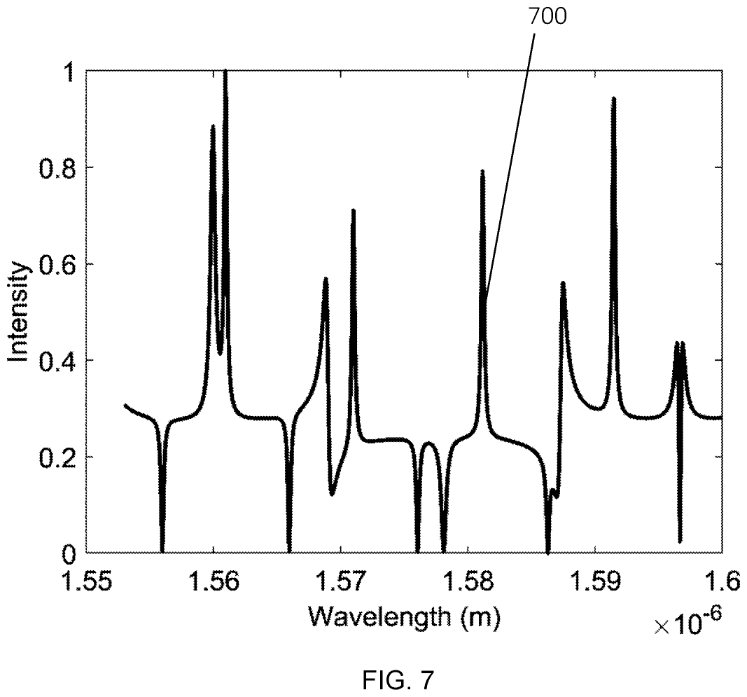

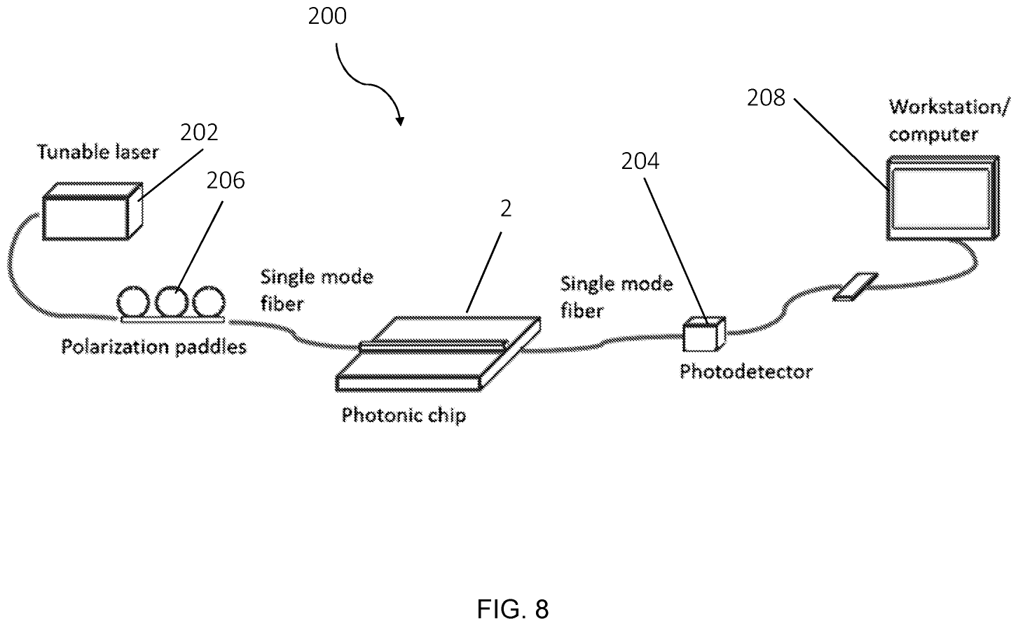

The spectrum of light output by the output 122 is illustrated in FIGS. 6 and 7. FIG. 6 which shows a first pattern of resonant peaks 602 corresponding to the first ring resonator 108 and a second pattern of resonant peaks 604 corresponding to the second ring resonator 109. The first and second patterns 602, 604 are shown separately in FIG. 6 for clarity but of course in reality a single output signal 700 shown in FIG. 7 is measured at the output 122 (i.e. comprising a superposition of the two signals shown in FIG. 6). Because the resonant peaks of the first and second patterns 602, 604 are generally narrow and sometimes fall at different wavelengths, it is possible to distinguish the two patterns from the spectrum of the single output signal 700—e.g. using corresponding cross-correlation operations. FIG. 8 is a simplified diagram of a sensing system 200 which comprises a light source (e.g. a tunable laser) 202, the optical sensing apparatus 2 described above with reference to FIGS. 1-4 and a light detector (e.g. a photodetector) 204. The sensing system may also be used with the optical sensing apparatus 102 illustrated in FIG. 5.

The light source 202 is arranged to provide monochromatic light with a configurable wavelength to the input interface 14 of the optical sensing apparatus 2. The light detector 204 is arranged to detect the intensity of light output by the output 22 of the optical sensing apparatus 2. Light from the light source 202 travels through single-mode optical fibres via polarisation paddles 206 to the input interface 14. The dimensions of the waveguides of the optical sensing apparatus 2 are chosen in such a way that only the fundamental mode of TE or TM propagates through them. The polarization paddles 206 are used to match the polarization of the input light to the mode (Single TE or TM mode) supported by the waveguides. Light from the output 22 travels through a single-mode optical fibre to the light detector 204, which is connected to a workstation 208 (e.g. a computer executing software) arranged to record and process the detected intensities for different wavelengths of input light to generate a spectrum.

The sensing system 200 is arranged to enable a user to determine one or more properties of a sample. The sample is added to the sample region 24 of the optical sensing apparatus 2 (e.g. by being washed over the upper face of the photonic chip 2), and a spectrum of light from the output 22 (i.e. the spectral response of the optical sensing apparatus 2) is measured by operating the light source to sweep the wavelength of light it produces over a predetermined range, whilst the intensity of light at the output 22 is measured using the light detector 204 and recorded by the processor 208. In some alternative embodiments, the input light may be generated by a broadband light source, and a spectrum analyser may be coupled to the output 22.

The spectrum comprises resonant peaks corresponding to resonances of the closed loop resonator 8. The position of these resonant peaks is compared to a control spectrum (corresponding to having a control sample in the sample region 24, such as an aqueous buffer solution) and a shift in the position of the peaks is calculated. Because the presence of the target analyte in the sample region 24 alters the refractive index, and hence optical path length, of the closed loop resonator 8, the shift in the positions of the resonant peaks can be used to detect the analyte and/or to determine one or more properties of the analyte (e.g. its concentration in the sample).

A series of spectra may be collected over time and analysed to determine further information about the sample.

In some embodiments, a photonic chip may have a larger number of ring resonators—e.g. three, five, ten or more—all arranged in parallel with the reference waveguide. Because their respective spectral signatures repeat only over a relatively long wavelength span, it can still be possible to identify each signature separately within the output intensity signal. Such multiplexing can enable a large number of analytes to be detected simultaneously.

In some embodiments, the interfering reference path may be provided at least partly outside the photonic chip. In some arrangements, the Y-branch splitter 5, 115 and/or the Y-branch combiner 9, 119 may be located off the chip—e.g. using a discrete beam splitter. The chip may have no reference waveguide, e.g. with the reference waveguide being provided by a separate optical fibre. The input interface 14, 114 may then be coupled only to the input waveguide 4, 104. Or the input interface 14, 114 may comprise a first port coupled to the input waveguide 4, 104 and a second port coupled to a reference waveguide portion (not shown). Similarly, the output interface 22, 122 may be coupled only to the output waveguide 12, 112, or it may comprise a first port coupled to the output waveguide 12, 112 and a second port coupled to a reference waveguide portion (not shown).

In some embodiments, there may be no first Y-branch combiner 116, and the second drop-port waveguide 110 may remain separate from the first drop-port waveguide 111. The second drop-port waveguide 110 may instead merge with the reference waveguide 106 at a separate Y-branch combiner, distinct from the second Y-branch combiner 119, and leave the chip 102 at a separate output port, as a second output signal.

In some embodiments, the apparatus is not a photonic chip, but is formed from discrete optical components, e.g. connected by optical fibres or through air.

### Example

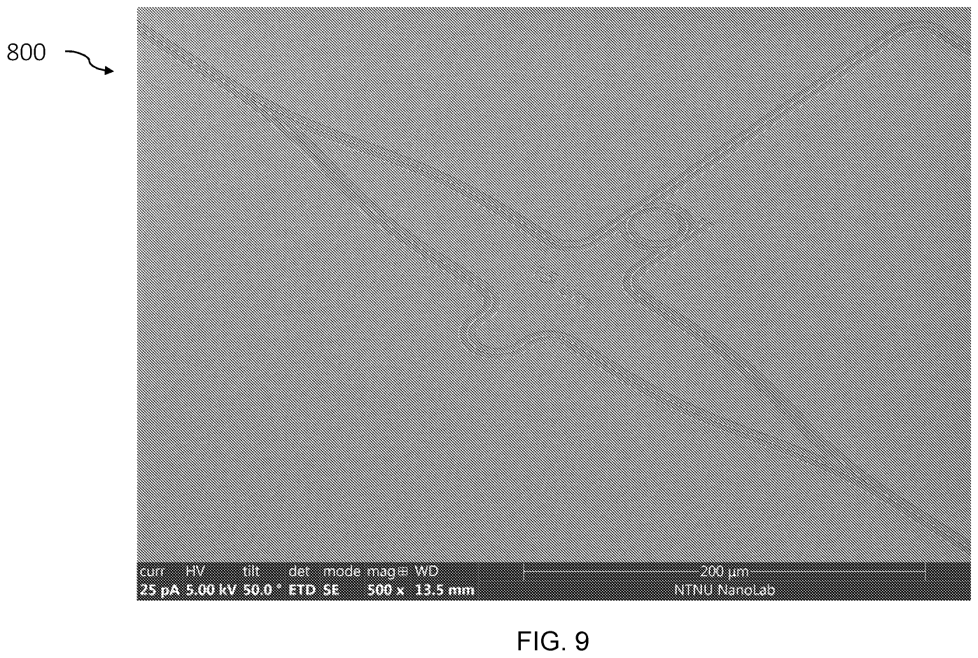

A photonic chip 800 was manufactured and is shown in FIG. 9. Its design is similar to that described above with reference to FIGS. 1 and 2. The photonic chip 800 comprises an input interface, an input waveguide, a reference waveguide, a circular waveguide ring resonator with a diameter of approximately 30 μm (i.e. with a path length of approximately 95 μm), a drop-port waveguide and an output waveguide. The input waveguide is configured to direct light from the input interface into the ring resonator, and the drop-port waveguide is configured to receive dropped light from the ring resonator. The input waveguide and the drop-port waveguide is optically coupled to the ring resonator at points separated by 180° (i.e. half the optical path length of the ring resonator). The ring resonator may be coated with a sensing layer to form an active sample region adjacent the ring resonator.

The reference waveguide and the drop-port waveguide merge at the output waveguide such that input light in the reference waveguide interferes with dropped light in the drop-port waveguide. The interfering light is directed through the output waveguide to a signal output. The input waveguide continues past the ring resonator to a through-port output.

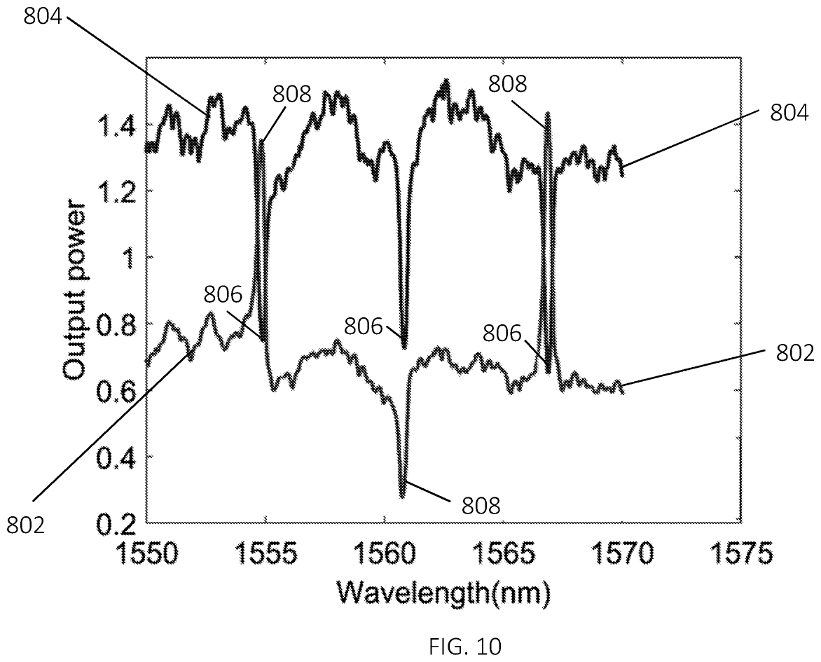

Monochromatic light was input to the input interface and the intensity of light output by the through-port output and the signal output was measured whilst the wavelength of the input light was varied, to produce an interference output spectrum 802 and a through-port output spectrum 804, which are shown in FIG. 10.

The through-port output spectrum 804 comprises a series of dips 806, with substantially the same intensity, at wavelengths corresponding to resonances of the ring resonator. The free spectral range of the through-port output spectrum 804 is equal to the separation of the resonance peaks, i.e. approximately 5 nm.

The output spectrum 802, however, comprises a pattern of resonance peaks 808 with intensities that alternate between a high value and a low value. The repetition period of the output spectrum 802 is thus equal to twice the separation of the resonance peaks, i.e. approximately 10 nm. This may correspond to a doubling in the dynamic range.

While the invention has been described in detail in connection with only a limited number of embodiments, it should be understood that the invention is not limited to such disclosed embodiments. Rather, the invention can incorporate any number of variations, alterations, substitutions or equivalent arrangements within the scope of the appended claims.

1. An optical sensing apparatus comprising:
an input interface for receiving input light into the optical sensing apparatus;
an input waveguide and a reference waveguide, both arranged to receive input light from the input interface;
a closed loop resonator, wherein the input waveguide is optically coupled to the closed loop resonator at an input point for introducing input light to the closed loop resonator;
a sample region, adjacent the closed loop resonator, for receiving a sample such that evanescent coupling can occur between light in the closed loop resonator and the sample;
a drop-port waveguide, optically coupled to the closed loop resonator at a drop point for receiving dropped light from the closed loop resonator;
an output waveguide; and
an output interface,
wherein the reference waveguide and the drop-port waveguide are arranged to direct interfering light through the output waveguide to produce an output signal at the output interface.

2. The optical sensing apparatus of claim 1, wherein the output signal has a spectral response to the input light that comprises a periodic pattern of resonance peaks that depends at least partially on a property of a sample in the sample region.

3. The optical sensing apparatus of claim 2, arranged such that the periodic pattern of resonance peaks has a period of at least three resonance peaks.

4. The optical sensing apparatus of claim 1, wherein the input point and the drop point are separated by less than half the optical path length of the closed loop resonator.

5. The optical sensing apparatus of claim 4, wherein the input point and the drop point are separated by less than 45% of an optical path length of the closed loop resonator.

6. The optical sensing apparatus of claim 1, wherein the input point and the drop point are separated by a submultiple of an optical path length of the closed loop resonator.

7. The optical sensing apparatus of claim 1, further comprising a through-port waveguide arranged to receive light from the input waveguide that does not couple into the closed-loop resonator and to direct said light to a through-port output interface.

8. The optical sensing apparatus of claim 1, wherein a total optical path length from the input interface to the output interface through the reference waveguide is equal to: an optical path length from the input interface to the input point of the closed loop resonator, plus an optical path length from the drop point of the closed loop resonator to the output interface.

9. The optical sensing apparatus of claim 1, further comprising a second closed loop resonator and a second sample region adjacent the second closed loop resonator, wherein the input waveguide is optically coupled to a second input point on the second closed loop resonator for introducing input light to the second closed loop resonator, and the drop-port waveguide is optically coupled to a second drop point on the second closed loop resonator for receiving dropped light from the second closed loop resonator.

10. The optical sensing apparatus of claim 9, wherein the sample region is spaced apart from the second sample region.

11. The optical sensing apparatus of claim 9, wherein a total optical path length from the input interface to the output interface through the reference waveguide is equal to: an optical path length from the input interface to the second input point, plus an optical path length from the second drop point to the output interface.

12. The optical sensing apparatus of claim 9, wherein the second closed loop resonator has a different optical path length to the closed loop resonator.

13. The optical sensing apparatus of claim 9, wherein the second input point and drop points are separated by a fraction of the optical path length of the second closed loop resonator that is equal to a fraction of the optical path length of the closed loop resonator by which the input and drop points are separated.

14. The optical sensing apparatus of claim 9, wherein the second input point and the second drop point are separated by a fraction of an optical path length of the second closed loop resonator different to a fraction of an optical path length of the closed loop resonator by which the input point and the drop point are separated.

15. The optical sensing apparatus of claim 9, wherein the drop-port waveguide comprises a first arm that is optically coupled to the closed loop resonator and a second arm that is optically coupled to the second closed loop resonator.

16. The optical sensing apparatus of claim 15, wherein the first and second drop-port waveguide arms are arranged such that an optical path length from the input interface to the input point plus an optical path length from the drop point to the output interface, is equal to an optical path length from the input interface to the second input point plus an optical path length from the second drop point to the to the output interface.

17. The optical sensing apparatus of claim 1, wherein the closed loop resonator has an optical path length of at least 100 μm.

18. The optical sensing apparatus of claim 1, being a photonic chip.

19. The optical sensing apparatus of claim 1, wherein the sample region comprises a sensing layer adjacent the closed loop resonator for binding an analyte in the sample region.

20. The optical sensing apparatus of claim 1, comprising an optical splitter comprising an input optically coupled to the input interface, a first output optically coupled to the reference waveguide, and a second output optically coupled to the input waveguide.

21. The optical sensing apparatus of claim 1, comprising an optical combiner comprising a first input optically coupled to the reference waveguide, a second input optically coupled to the drop-port waveguide, and an output optically coupled to the output waveguide.

22. A sensing system comprising:
an optical sensing apparatus, the optical sensing apparatus comprising:
an input interface for receiving input light into the optical sensing apparatus;
an input waveguide and a reference waveguide, both arranged to receive input light from the input interface;
a closed loop resonator, wherein the input waveguide is optically coupled to the closed loop resonator at an input point for introducing input light to the closed loop resonator;
a sample region, adjacent the closed loop resonator, for receiving a sample such that evanescent coupling can occur between light in the closed loop resonator and the sample;
a drop-port waveguide, optically coupled to the closed loop resonator at a drop point for receiving dropped light from the closed loop resonator;
an output waveguide; and
an output interface,
wherein the reference waveguide and the drop-port waveguide are arranged to direct interfering light through the output waveguide to produce an output signal at the output interface; and
wherein the sensing system further comprises:
a light source arranged to provide the input light to the input interface of the optical sensing apparatus; and
a light detector arranged to receive the output signal from the output interface of the optical sensing apparatus.

23. The sensing system of claim 22, wherein the light source comprises a tunable laser.

24. The sensing system of claim 23, wherein the light source comprises a tunable laser that has a tunable range which is equal to or greater than twice a free spectral range of the closed loop resonator, and/or which is equal to or greater than a period of a pattern of resonance peaks in the output signal.

25. The sensing system of claim 23, wherein the light source comprises a tunable laser that has a tunable range of 10 nm or less.

26. The sensing system of claim 22, further comprising a processing system arranged to receive an electrical signal from the light detector, wherein the processing system is configured to process the electrical signal to determine a property of a sample in the sample region.

27. The sensing system of claim 26, wherein the processing system is configured to:
determine data representative of a spectral response of the optical sensing apparatus to the input light;
access stored data representative of a predetermined spectral pattern;
analyse the spectral response to detect the predetermined spectral pattern in the spectral response;
determine a position of the predetermined spectral pattern within the spectral response; and
determine the property of the sample in the sample region at least in part based on said position.
